(19) United States
(12) Patent Application Publication
(10) Pub. No.: US 2019/0359255 A1
(43) Pub. Date: Nov. 28, 2019

(54) STEERING DEVICE FOR A VEHICLE

(71) Applicant: ZF Friedrichshafen AG, Friedrichshafen (DE)

(72) Inventors: Uwe FEHR, Friedrichshafen (DE); Jens HEIMANN, Stetten (DE); Alexander NEU, Friedrichshafen (DE)

(21) Appl. No.: 16/332,883

(22) PCT Filed: Aug. 8, 2017
(86) PCT No.: PCT/EP2017/069983

§ 371 Date: Mar. 13, 2019

(30) Foreign Application Priority Data
Sep. 16, 2016 (DE) 10 2016 217 782.6

(51) Int. Cl. B62D 7/09; B60G 7/00; B62D 7/20

(52) U.S. Cl. CPC B62D 7/09; B60G 7/006; B60G 2204/148; B60G 2200/44; B62D 7/20

(57) ABSTRACT

A steering device for a vehicle, having an actuator which is designed to apply an axial force to a push rod. The push rod is connected to a respective steering rod on both sides in an articulated manner, and each steering rod is connected to a respective steering arm in an articulated manner. Each steering arm is operatively connected to a respective wheel carrier in order to rotate a respective wheel of a vehicle axle about a respective steering axis according to an axial movement of the push rod and has at least one first and a second arm section. The two arm sections of each steering arm can be moved towards each other in an axial direction in order to change a transmission ratio of the steering device when the wheels are being steered and to reduce the axial force on the actuator.

This application is a National Stage completion of PCT/EP2017/069983 filed Aug. 8, 2017, which claims priority to German patent application serial no. 10 2016 217 782.6 filed Sep. 16, 2016.

### FIELD OF THE INVENTION

The invention relates to a steering device for a vehicle, in particular for a passenger car or a utility vehicle. The field of application of the invention extends both to independent suspensions and also to rigid axles of vehicles.

### BACKGROUND OF THE INVENTION

When independent suspensions are fitted in passenger cars and utility vehicles such as semitrailer tractors, rack-and-pinion steering systems are used. The rack-and-pinion steering system comprises a linear actuator which is connected to the wheel suspension by track rods.

By the nature of the system, rack-and-pinion steering systems have a very widely fluctuating transmission ratio between the actuator and the wheel movement. Owing to the extension in the end positions, here a comparatively large actuator force is needed. Accordingly, from the technical standpoint the performance of the actuator is designed such that the actuator force is sufficient to produce a maximum steering angle, although the torque applied at the steering axis of the wheel is almost constant over the steering angle.

DE 10 2006 052 252 A1 describes an independent suspension for a motor vehicle, in which at least one first and at least one second control arm are respectively articulated to a wheel carrier carrying a vehicle wheel. The independent suspension comprises compensation means for the correction of wheel positions, wherein at least the first and the second control arms have a compensation means or are connected to a compensation means and at least two compensation means of each wheel are connected to one another by at least one coupling element.

### SUMMARY OF THE INVENTION

The purpose of the present invention is to develop further a steering device for a vehicle, wherein in particular a steering kinematic of the steering device is improved.

This objective is achieved by the subject matter of the independent claims. Preferred design features are the object of the dependent claims.

The steering device for a vehicle according to the invention comprises an actuator provided in order to act upon a push-rod with an axial force, wherein the push-rod is articulated on each side to a respective track rod and wherein the respective track rod is articulated to a respective steering arm, wherein in order to turn a respective wheel of a vehicle axle about a respective steering axis in accordance with an axial movement of the push-rod the respective track rod is functionally connected to a respective wheel carrier, and comprises at least a first and a second arm section, wherein the two arm sections of the respective steering arm can move axially relative to one another in order to change a transmission ratio of the steering device during the steering of the wheels and in order to reduce the axial force on the actuator.

In other words, at each steering arm, whose axial length can be varied, a transmission ratio change takes place, whereby the maximum axial force that has to be applied by the actuator in order to produce a maximum steering angle is substantially reduced. Thus, in performance technology terms the actuator can be made smaller, and the power reduction of the actuator is at the same time accompanied by a weight reduction and a cost reduction. The actuator is of particularly compact design.

Furthermore, the system according to the invention offers greater freedom of design by the selection of the transmission ratio concerned. In particular, in that way a steering angle error can also be reduced.

In particular, the first arm section is held in the second arm section so that it can move. Depending on the steering angle of the respective wheel the axial length of the respective steering arm changes. Displacement of the two arm sections axially away from one another lengthens the steering arm concerned. In contrast, displacement of the two arm sections of the steering arm concerned axially toward one another shortens the steering arm.

An articulated connection is understood to mean that two components connected with one another in an articulated manner, for example the push-rod and the track rod, are connected to one another so that they can move relative to one another and have at least one degree of freedom. In particular the push-rod and the respective track rod are connected to one another by means of a ball joint. Preferably, the respective track rod is connected to the respective steering arm by means of a ball joint or by means of a rubber mounting.

Functionally connected is understood to mean that two elements can be connected directly to one another, or that between two elements there are further elements, for example one or more shafts, link rods or similar elements.

The invention makes use of the technical principle that the first arm section of the respective steering arm has a stud and the respective stud is held and guided in a groove formed on the respective wheel carrier. In particular, the first arm section of the steering arm concerned is articulated to the respective track rod and the second arm section of the steering arm is functionally connected to the respective wheel carrier. Moreover, on the respective wheel carrier or on a respective axle journal a groove is formed, which is provided in order to hold the stud formed on the first arm section of the steering arm concerned and guide it in a controlled manner. For this, the stud concerned projects radially out of the steering arm and is fitted so that it can move along the groove provided for it. Preferably, the groove is produced by milling.

According to a first example embodiment the groove on each wheel carrier is linear. Thus, the stud held in the respective groove is guided linearly, along a straight line.

According to a second example embodiment the groove on each wheel carrier is curved. Thus, the stud held in the respective groove is guided along a curve. Compared with a straight groove, during axial movement of the two arm sections a curved groove changes not only the length of the steering arm concerned but also its direction. The direction in each case is determined by the curvature of the groove and preferably describes a circular path, at least in part.

In a further preferred example embodiment, each steering arm is linear. Further, however, it is also conceivable to make each steering arm curved. During axial movement of the two arm sections, compared with a straight steering arm a curved steering arm changes not only the length of the respective steering arm but also its direction. The direction concerned is determined by the curvature of the steering arm and preferably describes a circular path, at least in part.

Furthermore, the curved structure of the respective steering arm or the respective groove enables a selective adjustment of a deviation from the ideal steering angle difference according to Ackermann. In particular it is made possible to minimize a so-termed steering error, which involves an approximation to the Ackermann ideal steering angle difference. An approximation to the Ackermann ideal steering angle difference reduces tire wear and the rolling resistance of the vehicle around curves. In contrast, an increasing deviation from the Ackermann steering angle difference reduces the turning circle of the vehicle.

Since the two wheels of a steered axle move along different curve radii, the wheels have different Ackermann angles. The steering angle of a wheel on the inside of the curve is larger than the steering angle of a wheel on the outside of the curve. The Ackermann steering angle difference increases with increasing steering angle. In particular, the respective steering angle at the wheel concerned can be adjusted by means of the shape of the respective steering arm or by means of the shape of the groove on the wheel carrier, in particular adjusted independently of one another. The independence of the wheels on the inside and outside of the curve makes it possible in particular for the wheel on the outside of the curve to deviate in a controlled manner from the Ackermann angle, in order to improve the driving dynamics of the vehicle. Thus, the design of the respective groove has a direct influence on the steering movement of the wheel concerned.

The invention makes use of the technical principle that the actuator is functionally connected to an input shaft, so that the actuator is provided in order to convert rotational movement of the input shaft into translation movement of the push-rod. Translational movement is understood to mean linear movement in the longitudinal direction of the push-rod.

The input shaft is at least indirectly connected to a steering means, preferably a steering wheel. The steering movement of the steering means is converted by the steering device into steering movement of the vehicle. For this, the rotational movement of the input shaft is converted by means of the actuator into the translation movement of the push-rod, wherein the push-rod co-operates with the respective wheel suspension and thus also with the respective wheel of the steerable vehicle axle by way of the respective deflection lever articulated thereto, the respective track rod articulated thereto and the respective steering arm articulated thereto.

The input shaft can be coupled to the push-rod by the actuator mechanically, electrically, pneumatically or hydraulically. Due to its simple production the mechanical coupling can preferably be provided by a rack and pinion combination. For this, there is for example on the input shaft a first gearwheel which meshes with a rack bar arranged on the push-rod. Rotation of the input shaft brings about rotation of the gearwheel which is engaged with the rack bar, whereby the rack bar together with the push-rod is displaced axially. Preferably the push-rod is in the form of a rack bar and is therefore integrated as one piece in the push-rod.

The electrical coupling of the input shaft with the push-rod can be designed such that a sensor is arranged on the input shaft, which detects rotation of the input shaft. On the other hand an actuator is arranged on the push-rod, which can displace the push-rod axially so that when rotation of the input shaft is detected by the sensor, the actuator is energized in order to move the push-rod correspondingly.

In the case of hydraulic or pneumatic coupling, for example on the input shaft one or more valves are arranged as sensors. When the input shaft rotates a pressure medium is passed into two working cylinders arranged on the push-rod, in such manner that a in each case a piston rod of the working cylinder moves in or out. In turn the piston rod is connected to the push-rod, which is moved axially when the piston rod moves in or out.

### BRIEF DESCRIPTION OF THE DRAWINGS

Below, preferred example embodiments of the invention are explained in greater detail with reference to the drawings, which show:

FIG. 1: A greatly simplified schematic view from above, of a steering device according to the invention with two steering arms whose length can be varied,

FIG. 2: A schematic sectioned representation of the steering arm according to the invention shown in FIG. 1, and

FIG. 3: A further schematic sectioned view of the steering arm according to the invention shown in FIG. 1.

### DETAILED DESCRIPTION OF THE PREFERRED EMBODIMENTS

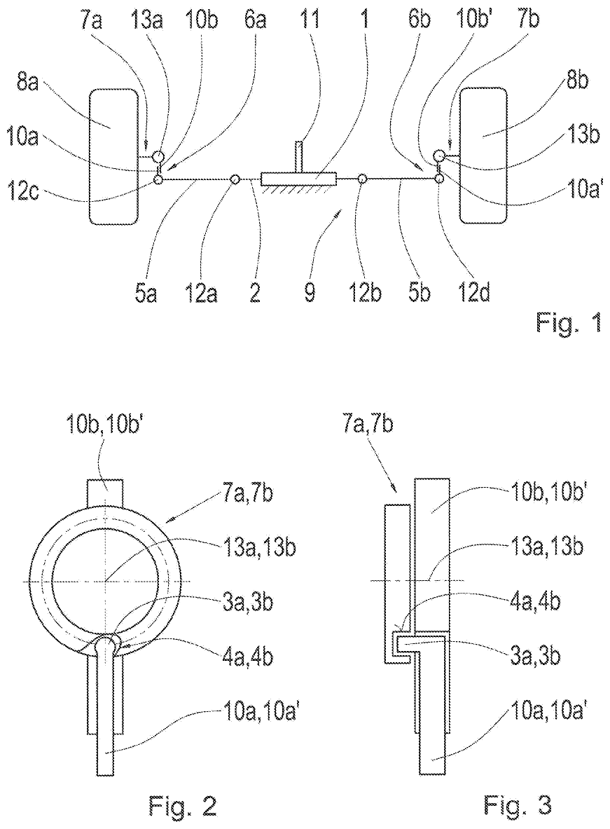

As shown in FIG. 1 a steering device according to the invention for a vehicle—not shown here—comprises an actuator 1 which is functionally connected to an input shaft 11 and a push-rod 2. The actuator 1 is provided in order to convert rotational movement of the input shaft 11 into a translation movement of the push-rod 2. Thus, when the input shaft 11 rotates in a first rotational direction the push-rod 2 moves axially toward a first wheel 8a. Correspondingly, when the input shaft 11 rotates in a second rotational direction the push-rod 2 moves axially toward a second wheel 8b. The two wheels 8a, 8b are part of a vehicle axle 9 and depending on the rotational movement of the input shaft 11 are turned by the steering device at least in part about a respective steering axis 13a, 13b.

The actuator 1 is designed to act upon the push-rod 2 with an axial force. In this case the push-rod 2 is made as one piece and has two distal ends. At each of the distal ends the push-rod 2 is articulated to a respective track rod 5a, 5b, and between the respective track rods 5a, 5b and the push-rod 2 is arranged a respective ball joint 12a, 12b. The respective track rod 5a, 5b is articulated to a respective steering arm 6a, 6b, and between the respective track rod 5a, 5b and the respective steering arm 6a, 6b a further respective ball joint 12c, 12d is arranged.

The respective steering arm 6a, 6b is functionally connected to a respective wheel carrier 7a, 7b in order to turn a respective wheel 8a, 8b of a vehicle axle 9 about the respective steering axis 13a, 13b in accordance with an axial movement of the push-rod 2. Furthermore, each steering arm 6a, 6b has a first and a second arm section 10a, 10b, 10a′, 10b′ such that the two arm sections 10a, 10b, 10a′, 10b′ of the respective steering arm 6a, 6b can be displaced axially relative to one another in order to change a transmission ratio of the steering device during the steering of the wheels 8a, 8b and to reduce the axial force on the actuator 1. In particular, each steering arm 6a, 6b of variable length generates a level transmission ratio, essentially constant over an entire steering angle range, at the steering device. The steering kinematics of the steering device are substantially improved.

FIGS. 2 and 3 show an enlarged depiction of the steering arm 6a, 6b shown only in greatly simplified form in FIG. 1. Although in FIGS. 2 and 3 only one of the two steering arms 6a, 6b is shown, the description applies to both of the steering arms 6a, 6b. The two steering arms 6a, 6b are identical and therefore structurally the same as one another. According to FIGS. 2 and 3 the first arm section 10a, 10a′ of the respective steering arm 6a, 6b has a stud 3a, 3b and the stud 3a, 3b is held and guided in a groove 4a, 4b formed in each respective wheel carrier 7a, 7b. The wheel carrier turns about the steering axis 13a, 13b in accordance with an axial movement of the push-rod 2.

The groove 4a, 4b in the respective wheel carrier 7a, 7b is curved. Due to the curved shape of each groove 4a, 4b, a steering error is minimized and as a result of that the tire wear and the rolling resistance of the vehicle are reduced. Moreover, each steering arm 6a, 6b is of linear shape. Thus, both the first arm section 10a, 10a′ and also the second arm section 10b, 10b′ of each steering arm 6a, 6b are straight.

The invention is not limited to the example embodiment described above. Other possibilities for further development can be derived from the description and the claims. In particular, individual articulated joints can also be made as rubber mountings. Furthermore other possible articulated joints are conceivable, which have at least one degree of freedom. In addition the groove 4a, 4b on the respective wheel carrier 7a, 7b can be linear. Advantageously, the respective steering arms 6a, 6b can additionally or alternatively be of curved shape.

### INDEXES

1 Actuator
2 Push-rod
3a, 3b Stud
4a, 4b Groove
5a, 5b Track rod
6a, 6b Steering arm
7a, 7b Wheel carrier
8a, 8b Wheel
9 Vehicle axle
10a, 10a′ First arm section
10b, 10b′ Second arm section
11 Input shaft
12a-12d Ball joint
13a, 13b Steering axis

1-9. (canceled)

10. A steering device for a vehicle, comprising an actuator (1) provided to act upon a push-rod (2) with an axial force, the push-rod (2) is articulated on both sides to a respective track rod (5a, 5b), and the respective track rod (5a, 5b) is articulated to a respective steering arm (6a, 6b), to turn a respective wheel (8a, 8b) of a vehicle axle (9) about a respective steering axis (13a, 13b) in accordance with an axial movement of the push-rod (2) the steering arm (6a, 6b) concerned is functionally connected to a respective wheel carrier (7a, 7b) and has at least a first and a second arm section (10a, 10b, 10a′, 10b′), such that the first and the second arm sections (10a, 10b, 10a′, 10b′) of the steering arm concerned are movable axially relative to one another, to change a transmission ratio of the steering device during the steering of the wheels (8a, 8b) and to reduce axial force on the actuator (1), the first arm section (10a, 10a′) of the steering arm (6a, 6b) concerned has a stud (3a, 3b) and the stud (3a, 3b) is held and guided in a groove (4a, 4b) formed in the respective wheel carrier (7a, 7b).

11. The steering device according to claim 10, wherein the groove (4a, 4b) in the respective wheel carrier (7a, 7b) is linear.

12. The steering device according to claim 10, wherein the groove (4a, 4b) in the respective wheel carrier (7a, 7b) is curved.

13. The steering device according to claim 10, wherein the respective steering arm (6a, 6b) is linear.

14. The steering device according to claim 10, wherein the respective steering arm (6a, 6b) is curved.

15. The steering device according to claim 10, wherein the actuator (1) is functionally connected to an input shaft (11), and the actuator (1) is provided in order to convert rotational movement of the input shaft (11) into translational movement of the push-rod (2).

16. The steering device according to claim 10, wherein the push-rod (2) is in a form of a rack bar.

17. Use of a steering device according to claim 10 in a passenger car or a utility vehicle.
